(19) United States
(12) Patent Application Publication
(10) Pub. No.: US 2011/0159280 A1
(43) Pub. Date: Jun. 30, 2011

(54) BACKSHEET FOR A SOLAR MODULE

(75) Inventor: Stephen Yau-Sang Cheng, New Territories (HK)

(73) Assignee: Du Pont Apollo Limited, Pak Shek Kok (HK)

(21) Appl. No.: 12/980,550

(22) Filed: Dec. 29, 2010

Related U.S. Application Data
(60) Provisional application No. 61/291,643, filed on Dec. 31, 2009.

(51) Int. Cl. B32B 27/32; B32B 7/02; B32B 27/06

(52) U.S. Cl. 428/339; 428/412; 428/521; 428/475.5; 428/447; 428/475.8; 428/519; 428/458; 428/462

(57) ABSTRACT

Disclosed herein is a backsheet for a solar module. The backsheet includes a first polymeric layer, a second polymeric layer and a moisture-resistant layer. The first polymeric layer includes linear low-density polyethylene (LLDPE), low-density polyethylene (LDPE), medium-density polyethylene (MDPE), high-density polyethylene (HDPE) or polycarbonate (PC). The second polymeric layer includes linear low-density polyethylene (LLDPE), low-density polyethylene (LDPE), medium-density polyethylene (MDPE), high-density polyethylene (HDPE), polycarbonate (PC) or Nylon. The moisture-resistant layer is disposed between the first polymeric layer and the second polymeric layer.

### RELATED APPLICATIONS

This application claims priority to U.S. Provisional Application Ser. No. 61/291,643, filed Dec. 31, 2009, which is herein incorporated by reference.

### BACKGROUND

1. Field of Invention

The present invention relates to an encapsulating sheet. More particularly, the present invention relates to a backsheet for a solar module.

2. Description of Related Art

Solar energy has gained many research attentions for being a seemingly inexhaustible energy source. For such purpose, solar modules that convert solar energy directly into electrical energy are developed.

In general, the solar module mechanically supports the solar cells, and protects the solar cells against environmental degradation. The solar module generally comprises a rigid and transparent protective front panel such as glass, and a rear panel or sheet, which is typically called a backsheet. The front panel and backsheet encapsulate the solar cell(s) and provide protection from environmental damage.

A goal of the solar industry, however, is to have solar modules with an effective lifetime of decades, e.g. 20 years. Thus, the backsheet are concerned for providing adequate resistance to damage from impact and thermal shock, and also minimizing degradation from moisture, temperature, and ultraviolet radiation. A further concern of the backsheet is that it should be at a commercially acceptable cost.

A known backsheet comprising polyvinyl fluoride or other fluorinated polymers such as polyethylenetetrafluoroethylene or polyethylenechlorotrifluoroethylene is disclosed in the prior art. Unfortunately, fluorinated polymers are generally expensive. In addition to fluorinated polymers, other polymers that are used in the backsheet are also costly. For example, polyethyleneterephthate, which has undergone costly orientation processes to form oriented films, is also a part of the backsheet structure. Polyimide which can be used as part of the backsheet structure for flexible photovoltaic modules is also an expensive polymer. Therefore, there exists in this art a need of an improved backsheet, which would have a lower cost.

### SUMMARY

The present disclosure provides a backsheet for a solar module. The backsheet includes a first polymeric layer, a second polymeric layer and a moisture-resistant layer. The first polymeric layer includes at least one polymer selected from the group consisting of linear low-density polyethylene (LLDPE), low-density polyethylene (LDPE), medium-density polyethylene (MDPE), high-density polyethylene (HDPE) and polycarbonate(PC). The second polymeric layer has a melting point of larger than 90° C., and includes at least one polymer selected from the group consisting of linear low-density polyethylene (LLDPE), low-density polyethylene (LDPE), medium-density polyethylene (MDPE), high-density polyethylene (HDPE), polycarbonate(PC) and Nylon. The moisture-resistant layer is disposed between the first polymeric layer and the second polymeric layer.

### BRIEF DESCRIPTION OF THE DRAWINGS

The invention can be more fully understood by reading the following detailed description of the embodiment, with reference made to the accompanying drawings as follows:

FIG. 1 is a cross-sectional view illustrating a backsheet according to one embodiment of the present disclosure

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

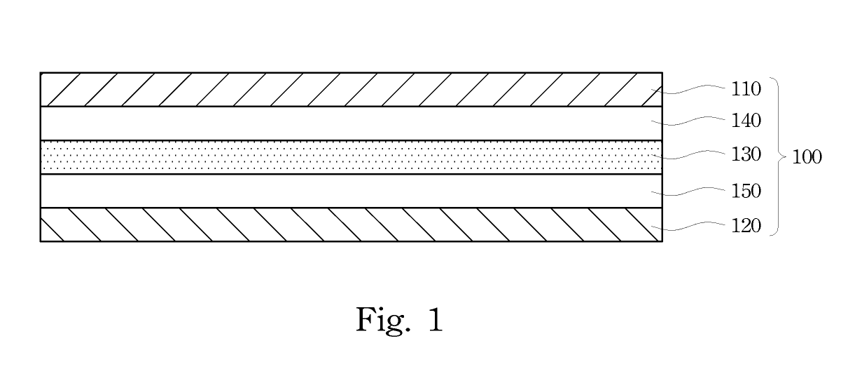

A backsheet for a photovoltaic module is disclosed hereinafter. FIG. 1 is a cross-sectional view of a backsheet 100 according to one embodiment of the present disclosure. As depicted in FIG. 1, the backsheet 100 includes a first polymeric layer 110, a second polymeric layer 120 and a moisture-resistant layer 130.

The first polymeric layer 110 is uses for adhering to a solar cell. Suitable materials for the first polymeric layer 110 include, but are not limited to, linear low-density polyethylene (LLDPE), low-density polyethylene (LDPE), medium-density polyethylene (MDPE), high-density polyethylene (HDPE) and polycarbonate (PC). In the present disclosure, the LDPE refers to polyethylene having a density range of 0.910-0.940 g/cm³. The MDPE refers to polyethylene having a density range of 0.926-0.940 g/cm³. The HDPE refers to polyethylene having a density range of larger or equal to 0.941 g/cm³. In some embodiments, the first polymeric layer 110 may be made from a polymer blend containing at least one of the above mentioned polymers. For example, the polymer blend may be a mixture of HDPE and other grades of HDPE resins, MDPE, LDPE and LLDPE. In addition, the first polymeric layer disclosed herein is made from inexpensive polymers such as PE or PC, and thereby the cost of the backsheet may be decreased.

In one embodiment, the first polymeric layer 110 has a thickness of about 0.05 mm to about 2 mm, and the melting point of the first polymeric layer 110 is greater than 90° C., which is measured by a differential scanning calorimetry. In one example, the first polymeric layer 110 is made of HDPE having a melting point of about 110° C. to about 130° C. In other examples, the first polymeric layer 110 is made of PC, with a melting point of about 267° C.

In another embodiment, the first polymeric layer 110 may further comprise a modifier such as stabilizers, pigments and fillers so as to modify the physical properties of the first polymeric layer 110, i.e. mechanical strength, color, etc. For example, about 0.1 weight % to about 300 weight %, relative to the total polymer content in the first polymeric layer 110, of fillers may be added into the first polymeric layer 110. Furthermore, a coupling agent such as silane may optionally be added into the first polymeric layer 110 for enhancing the bonding between the polymeric material and the modifier such as a filler or a pigment. The weight percentage of the coupling agent may be in the range of about 0.1 to about 20 weight % relative to the total polymer content, for example.

In other embodiments, the material of the first polymeric layer 110 may further comprise a grafting agent, and thereby imparting polarity or sites for chemical reactivity. For instance, the grafting agent may be acrylic acids or maleic anhydrides. In some examples, the material of the first polymeric layer 110 may further comprise a chemical cross-linking agent such as organic peroxides. For example, the organic peroxide may be dicumylperoxide, 1-di(tert-butylperoxy)-3,3,5-trimethylcyclohexane, a,a′-bis(tert-butylperoxy)-diisoproplybenzene or the combination thereof. The weight percentage of the cross-linking agent may be in the range of about 0.1 to about 5 weight % relative to the total polymer content in the first polymeric layer 110, for example.

In some embodiments, the material of the first polymeric layer 110 does not experience UV aging and/or heat agent so as to prevent the original polymer chain from chain scission. In these embodiments, the first polymeric layer 110 may provide a desirable mechanical strength.

There is no specific limitation on the method of forming the first polymeric layer 110. For example, the first polymeric layer 110 may be formed by extrusion or calendaring method as known in the art. In one example, an orientation process may optionally be employed to modify the surface or mechanical property of the first polymeric layer 110. In some examples, the first polymeric layer 110 is exposed to a radiation such as an electron beam so as to facilitate the cross-linking of the first polymeric layer 110.

The second polymeric layer 120 may provide a function of weather resistance. The second polymeric layer 120 has a melting point greater than 90° C., which is measured by a differential scanning calorimetry. The second polymeric layer 120 may be made from a single polymer or a polymer blend. In one example, the second polymeric layer 120 is made of linear low-density polyethylene (LLDPE), low-density polyethylene (LDPE), medium-density polyethylene (MDPE), high-density polyethylene (HDPE), polycarbonate (PC) or Nylon. In some examples, the first polymeric layer 110 may be made from a polymer blend containing at least one of the above mentioned polymers. For example, the polymer blend may be a mixture of HDPE and other grades of HDPE resins, MDPE, LDPE and LLDPE. In some embodiments, the second polymeric layer 120 has a thickness of about 0.05 mm to about 2 mm, and is usually exposed to the ambient environment directly. In other embodiments, the first and the second polymeric layers may be made of the same material. The second polymeric layer disclosed herein is made from inexpensive polymers such as PE, PC, or Nylon, and thereby the cost of the backsheet may be decreased.

In some embodiments, the second polymeric layer 120 may further comprise a modifier such as stabilizers, pigments and fillers so as to modify the physical properties of the second polymeric layer 120, i.e. mechanical strength, color, etc. In one example, about 0.1 weight % to about 300 weight %, relative to the total polymer content in the second polymeric layer 120, of fillers may be added into the second polymeric layer 120. In another example, a coupling agent such as silane may be further added into the second polymeric layer 120 for enhancing the bonding between the polymeric material and the modifier such as a filler or a pigment. The weight percentage of the coupling agent may be in the range of about 0.1 to about 20 weight % relative to the total polymer content, for example.

In other embodiments, the material of second polymeric layer 120 may further comprises a grafting agent, and thereby imparting polarity or sites for chemical reactivity. For instance, the grafting agent may be acrylic acids or maleic anhydrides. In some examples, the material of the second polymeric layer 120 may further comprise a chemical cross-linking agent such as organic peroxides. For example, the organic peroxide may be dicumylperoxide, 1-di(tert-butylperoxy)-3,3,5-trimethylcyclohexane, a,a′-bis(tert-butylperoxy)-diisoproplybenzene or the combination thereof. The weight percentage of the cross-linking agent may be in the range of about 0.1 to about 5 weight % relative to the total polymer content, for example.

In some embodiments, the material of the second polymeric layer 120 does not experience UV aging and/or heat agent so as to prevent the original polymer chain from chain scission. In these embodiments, the second polymeric layer 120 may provide a desirable mechanical strength.

There is no specific limitation on the method of forming the second polymeric layer 120. For example, the second polymeric layer 120 may be formed by extrusion or calendaring method as known in the art. In one example, an orientation process may optionally be employed to modify the surface or mechanical property of the second polymeric layer 120. In some examples, second polymeric layer 120 is exposed to a radiation such as an electron beam so as to facilitate the cross-linking of the second polymeric layer 120.

The moisture-resistant layer 130 may provide a function of moisture resistance, and is disposed between the first polymeric layer 110 and the second polymeric layer 120. The moisture-resistant layer 130 may be composed of a single layer or multiple layers. In one embodiment, the moisture-resistant layer 130 may be made from a polymeric material. In one example, the moisture-resistant layer 130 may be a layer of polyvinylidene chloride (PVDC), or a layer of copolymer of ethylene and vinyl alcohol (EVOH). In another example, the moisture-resistant layer 130 may have a two-layer structure composed of a PVDC layer and an EVOH layer. In some embodiments, the moisture-resistant layer 130 may be made from a metallic material such as aluminum or stainless steel. For example, the moisture-resistant layer 130 may be an aluminum layer formed by sputtering. Alternatively, the moisture-resistant layer 130 may be an aluminum foil. In some examples, the moisture-resistant layer 130 has a thickness of about 0.001 mm to about 2 mm.

In one embodiment, the backsheet 100 may further comprise a first adhesive layer 140 and a second adhesive layer 150. The first adhesive layer 140 is disposed between the first polymeric layer 110 and the moisture-resistant layer 130, while the second adhesive layer 150 is disposed between the second polymeric layer 120 and the moisture-resistant layer 130, as depicted in FIG. 1. The material of the first adhesive layer 140 may be same as or different from the second adhesive layer 150. The first and/or second adhesive layer(s) may comprise ethylene-vinyl acetate (EVA) or polyvinyl butyral (PVB), for example. In some embodiment, both the first and second adhesive layers are about 0.01 mm to about 0.5 mm in thickness.

In one example, the first adhesive layer 140 may be formed by the steps of: (1) coating a layer of water-based or solvent-based adhesive solution on the first polymeric layer 110 (or on the moisture-resistant layer 130); (2) layering the moisture-resistant layer 130 (or the first polymeric layer 110) on the layer of adhesive solution; and (3) subjecting the multi-layered structure to an environment at a temperature of about 80° C. to remove water or solvent. The temperature of removing water or solvent may be performed at any temperature which does not deform the first polymeric layer 110 or the moisture-resistant layer 130 in the time period needed to dry the water or solvent. In another example, the first adhesive layer 140 is formed by coating a molten adhesive, which can be reactivated at a later time by applying a solvent to the adhesive layer 140. The second adhesive layer 150 may be formed on the moisture-resistant layer 130 or on the second polymeric layer 120 by the methods described above.

The method of forming the backsheet 100 is not limited. In one embodiment, both the first adhesive layer 140 and first polymeric layer 110 may simultaneously be coated on a surface of the moisture-resistant layer 130 by a co-extrusion process. Afterwards, both the second adhesive layer 150 and the second polymeric layer 120 are simultaneously coated on the opposite surface of the moisture-resistant layer 130. As a result, the backsheet 100 may be manufactured. Furthermore, the backsheet 100 may be formed by a single step by co-extrusion the first adhesive/first polymeric layers and the second adhesive/second polymeric layers on both side of the moisture-resistant layer 130 simultaneously.

In one embodiment, the first polymeric layer 110 of the backsheet 100 may be directly adhered to a solar cell by exerting heat to the first polymeric layer 110 because the first polymeric layer 110 disclosed herein is a thermoplastic polymer such as PE or PC. Therefore, an additional adhesive is no longer required and thus the running cost of assembling the solar cell and the backsheet may be decreased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A backsheet for a photovoltaic module, comprising:
a first polymeric layer comprising at least one polymer selected from the group consisting of linear low-density polyethylene (LLDPE), low-density polyethylene (LDPE), medium-density polyethylene (MDPE), high-density polyethylene (HDPE) and polycarbonate (PC);
a second polymeric layer having a melting point higher than 90° C. measured by a differential scanning calorimetry, wherein the second polymeric layer comprises at least one polymer selected from the group consisting of linear low-density polyethylene (LLDPE), low-density polyethylene (LDPE), medium-density polyethylene (MDPE), high-density polyethylene (HDPE), polycarbonate (PC) and Nylon; and
a moisture-resistant layer disposed between the first polymeric layer and the second polymeric layer.

2. The backsheet according to claim 1, further comprising a first adhesive layer disposed between the first polymeric layer and the moisture-resistant layer, wherein the first adhesive layer has a thickness of about 0.01 mm to about 0.5 mm.

3. The backsheet according to claim 1, further comprising a second adhesive layer disposed between the second polymeric layer and the moisture-resistant layer, wherein the second adhesive layer has a thickness of about 0.01 mm to about 0.5 mm.

4. The backsheet according to claim 1, wherein the first polymeric layer has a melting point of higher than 90° C. measured by a differential scanning calorimetry.

5. The backsheet according to claim 4, wherein the first polymeric layer further comprises at least one modifier selected from the group consisting of a stabilizer, a pigment, a filler and a coupling agent.

6. The backsheet according to claim 5, wherein the coupling agent comprises silane.

7. The backsheet according to claim 4, wherein the first polymeric layer further comprises a grafting agent.

8. The backsheet according to claim 7, wherein the grafting agent comprises at least one of acrylic acid and maleic anhydrides.

9. The backsheet according to claim 4, wherein the first polymeric layer further comprises a chemical cross-linking agent containing an organic peroxide.

10. The backsheet according to claim 9, wherein the organic peroxide is at least one selected from the group consisting of dicumylperoxide, 1-di(tert-butylperoxy)-3,3,5-trimethylcyclohexane and a,a′-bis(tert-butylperoxy)-diisoproplybenzene.

11. The backsheet according to claim 1, wherein the moisture-resistant layer comprises a polymer selected from the group consisting of polyvinylidene chloride (PVDC) and a copolymer of ethylene and vinyl alcohol (EVOH).

12. The backsheet according to claim 1, wherein the moisture-resistant layer is made of aluminum or stainless steel.

13. The backsheet according to claim 1, wherein the second polymeric layer further comprises at least one modifier selected from the group consisting of a stabilizer, a pigment, a filler and a coupling agent.

14. The backsheet according to claim 1, wherein the second polymeric layer further comprises a grafting agent.

15. The backsheet according to claim 14, wherein the grafting agent comprises at least one of acrylic acid and maleic anhydrides.

16. The backsheet according to claim 1, wherein the second polymeric layer further comprises a chemical cross-linking agent containing an organic peroxide.

17. The backsheet according to claim 16, wherein the organic peroxide is at least one selected from the group consisting of dicumylperoxide, 1-di(tert-butylperoxy)-3,3,5-trimethylcyclohexane and a,a′-bis(tert-butylperoxy)-diisoproplybenzene.

18. The backsheet according to claim 1, wherein the first polymeric layer has a thickness of about 0.05 mm to about 2 mm.

19. The backsheet according to claim 1, wherein the second polymeric layer has a thickness of about 0.05 mm to about 2 mm.

20. The backsheet according to claim 1, wherein the moisture-resistant layer has a thickness of about 0.001 mm to about 2 mm.
